(19) United States
(12) Patent Application Publication
(10) Pub. No.: US 2022/0329427 A1
(43) Pub. Date: Oct. 13, 2022

(54) NON FUNGIBLE TOKENS (NFTS) FOR DECENTRALIZED CAMPAIGN/ATO PLANNING AND EXECUTION

(71) Applicant: VeriTX Corp., Buffalo, NY (US)

(72) Inventor: James Allen Regenor, East Aurora, NY (US)

(21) Appl. No.: 17/718,252

(22) Filed: Apr. 11, 2022

Related U.S. Application Data
(60) Provisional application No. 63/173,006, filed on Apr. 9, 2021.

(51) Int. Cl. H04L 9/32; H04L 9/00; B64D 7/00

(52) U.S. Cl. CPC H04L 9/3213; H04L 9/50; B64D 7/00

(57) ABSTRACT

Blockchain technology is used to generate and maintain Non Fungible Tokens (NFTs) for use in combat planning and execution.

### CROSS-REFERENCE TO RELATED APPLICATIONS

This application claims the benefit of U.S. Provisional Application 63/173,006 filed Apr. 9, 2021 and entitled “Non Fungible Tokens (NFTs) for Decentralized Campaign/ATO Planning and Execution”, the contents of which are hereby incorporated in their entirety.

### BACKGROUND OF THE INVENTION

This invention is generally directed to blockchain technology and more specifically to the generation and manipulation of Non Fungible Tokens (NFTs) for use in combat scenarios.

### SUMMARY OF THE INVENTION

Blockchain Non Fungible Tokens (NFTs) are leveraged to create a decentralized Air Tasking Order (ATO) that updates using bomb damage assessment and target tasking in near real time via a target exchange platform. Targets may be converted to Non Fungible Tokens and those tokens may be utilized and prioritized by Plans and Current Ops with the development of the prioritized target list.

### DESCRIPTION OF THE DRAWINGS

FIG. 1 shows an exemplary flow of an embodiment of a blockchain method in accordance with the present invention.

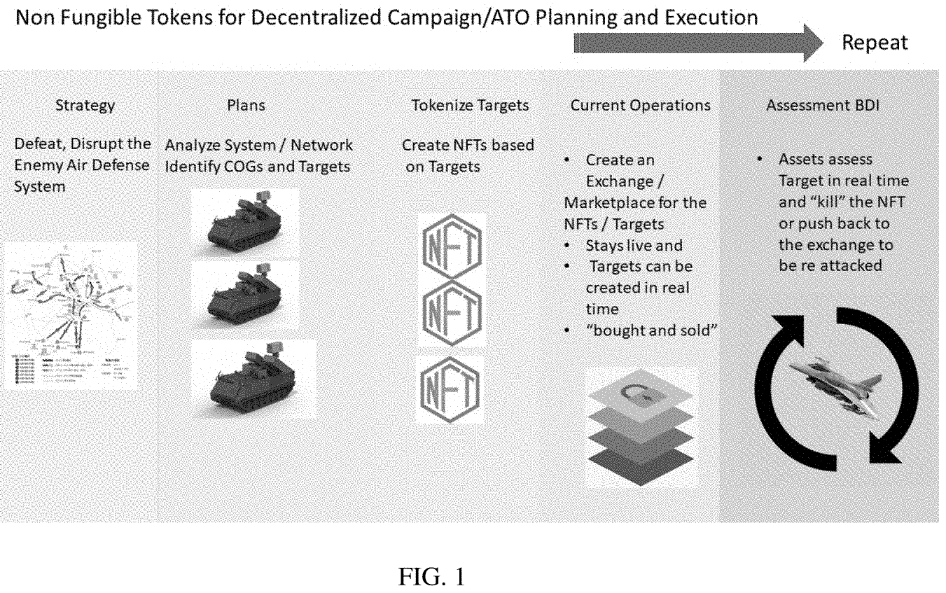

### DETAILED DESCRIPTION

Blockchain Non Fungible Tokens (NFTs) are leveraged to create a decentralized Air Tasking Order (ATO) that updates using bomb damage assessment and target tasking in near real time via a target exchange platform. Today the ATO cycle time is 72 hours and not compressible. In accordance with an embodiment of the present invention, a solution allows for the creation of targets congruent with the strategy. The targets are then converted to Non Fungible Tokens. These tokens are utilized and prioritized by Plans and Current Ops with the development of a prioritized target list. That target list is coordinated and deconflicted with the Joint Fires Board. The targets/NFTs are then assigned to a unit for the tactical execution planning. Once attacked the target is assessed for the desired effect. If needed to be re-attacked, the NFT is sent back to the exchange and reprioritized by way of an AI application. All tactical data is available in the NFT and it can be pushed for immediate re-attack or reprioritization. The solution allows for compression of the ATO cycle time and brings the Air Operations Center up to the most advanced data centers.

Each NFT (target) also has blockchain provenance traceable back to the strategy, with all the associated raw intelligence, assessment, prioritization, execution and BDI connected and tracked via the blockchain being hashed.

What is claimed is:

1. A decentralized Air Tasking Order (ATO) utilizing blockchain technology to convert a military target to a non-fungible token (NFT), wherein the NFT is prioritized and monitored during attack, wherein when the military target is incapacitate the NFT is terminated and wherein when the military target needs to be re-attacked the NFT reprioritized and monitored.
